(19) United States
(12) Patent Application Publication
(10) Pub. No.: US 2014/0232107 A1
(43) Pub. Date: Aug. 21, 2014

(54) HIGH-FLOW HOSE FITTING

(71) Applicant: Briggs & Stratton Corporation, Wauwatosa, WI (US)

(72) Inventor: Jason J. Raasch, Cedarburg, WI (US)

(21) Appl. No.: 14/183,312

(22) Filed: Feb. 18, 2014

Related U.S. Application Data
(60) Provisional application No. 61/766,634, filed on Feb. 19, 2013.

(51) Int. Cl. F16L 33/00; F16L 33/22

(52) U.S. Cl. CPC F16L 33/00; F16L 33/22
USPC 285/257; 29/428

(57) ABSTRACT

A high-flow hose assembly includes a hose, a fitting, and a ferrule. The hose includes an outer surface and an inner surface. In an unsecured configuration, an insertion portion of the fitting is positioned within a hose passage and the hose is positioned within a ferrule passage, and the inner surface of the insertion portion defines a first diameter and the outer surface of the insertion portion defines a second diameter. In a secured configuration, the inner surface of the insertion portion defines a third diameter greater than the first diameter and the outer surface of the insertion portion defines a fourth diameter greater than the second diameter, so that fitting barbs engage the inner surface of the hose and ferrule barbs engage the outer surface of the hose to secure the hose, the fitting, and the ferrule together.

### CROSS-REFERENCE TO RELATED PATENT APPLICATIONS

This application claims priority to and the benefit of Application Ser. No. 61/766,634, filed Feb. 19, 2013, which is incorporated herein by reference in its entirety.

### BACKGROUND

Typically, high-pressure hoses (e.g., pressure washer hoses) are equipped with a fitting on at least one end to allow for simple and secure connection to a pressure washer, a spray gun, hose wand, etc. These fittings are typically barbed along a certain length and are generally connected to the hose via an externally crimped-on ferrule. That is, the barbed portion of the fitting is slid into an inside diameter of the hose, and a ferrule is placed over the outside diameter of the hose around the portion where the fitting is internally located. The ferrule is then compressed (or crimped) until it provides enough clamp load on the hose to secure the hose to the barbs of the fitting. For example, a high-pressure hose assembly may include a fitting at either end of the hose, one fitting for connection to the pressure washer to receive a pressurized water flow from a water pump and the other fitting for connection to a spray gun.

With the hose fitting connection described above, the barbed portion of the fitting has to be sized to slide into the hose's inside diameter while still having enough wall thickness to withstand the clamping load from the ferrule. As a result, the inside diameter of the fitting itself is quite small relative to the inside diameter of the hose. This creates a restriction that leads to non-optimal flow characteristics of the fluid exiting the hose.

Accordingly, it would be advantageous to have a hose fitting for high-pressure or high-flow applications that is capable of reduced flow restriction at the fitting location.

### SUMMARY

One embodiment of the invention relates to a high-flow hose assembly including a hose, a fitting, and a ferrule. The hose includes an outer surface and an inner surface. The inner surface defines a hose passage. The fitting includes a head, an insertion portion, and a fitting passage extending through the head and the insertion portion. The insertion portion has an outer surface including multiple fitting barbs and an inner surface defining a portion of the fitting passage. The ferrule includes an outer surface and an inner surface including multiple ferrule barbs. The inner surface defines a ferrule passage. In an unsecured configuration, the insertion portion of the fitting is positioned within the hose passage and the hose is positioned within the ferrule passage, and the inner surface of the insertion portion defines a first diameter and the outer surface of the insertion portion defines a second diameter. In a secured configuration, the insertion portion of the fitting is positioned within the hose passage and the hose is positioned within the ferrule passage, and the inner surface of the insertion portion defines a third diameter greater than the first diameter and the outer surface of the insertion portion defines a fourth diameter greater than the second diameter, so that the fitting barbs engage the inner surface of the hose and the ferrule barbs engage the outer surface of the hose to secure the hose, the fitting, and the ferrule together.

Another embodiment of the invention relates to a high-flow hose fitting including a head, an insertion portion, and a fitting passage. The head includes an inner surface. The insertion portion includes an outer surface including multiple fitting barbs and an inner surface. The fitting passage extends through the head and the insertion portion and the inner surfaces of the head and the insertion portion define the fitting passage. In an initial configuration, the inner surface of the insertion portion defines a first diameter and the outer surface of the insertion portion defines a second diameter. In an expanded configuration, the inner surface of the insertion portion defines a third diameter greater than the first diameter and the outer surface of the insertion portion defines a fourth diameter greater than the second diameter.

Another embodiment of the invention relates to a method of securing a fitting to a hose including arranging a fitting, a hose, and a ferrule so that a barbed portion of the fitting is positioned within an end portion of the hose and the end portion of the hose is positioned within a barbed portion of the ferrule, inserting an expansion tool into the fitting, and actuating the expansion tool to expand the fitting so that the barbed portion of the fitting engages the inner surface of the hose and the barbed portion of the ferrule engages the outer surface of the hose to secure the hose, the fitting, and the ferrule together.

Alternative exemplary embodiments relate to other features and combinations of features as may be generally recited in the claims.

### BRIEF DESCRIPTION OF THE FIGURES

The invention will become more fully understood from the following detailed description, taken in conjunction with the accompanying drawings, in which:

FIG. 1 is a front view of a conventional hose fitting;

FIG. 2 is a perspective view of a high-flow hose assembly including a high-flow hose fitting, a hose, and a ferrule, according to an exemplary embodiment;

FIG. 3 is a front view of the high-flow hose fitting of FIG. 2 in an expanded configuration;

FIG. 4 is a sectional view of a portion of the high-flow hose assembly of FIG. 2 in an unsecured configuration;

FIG. 5 is a sectional view of a portion of the high-flow hose assembly of FIG. 2 in a secured configuration;

FIG. 6 is a perspective view of the high-flow hose fitting of FIG. 2, in an initial configuration;

FIG. 7 is a side view of the high-flow hose fitting of FIG. 6;

FIG. 8 is a front view of the high-flow hose fitting of FIG. 6;

FIG. 9 is a sectional view of the high-flow hose fitting of FIG. 6;

FIG. 10 is a perspective view of the ferrule of FIG. 2;

FIG. 11 is a front view of the ferrule of FIG. 2;

FIG. 12 is a sectional view of the ferrule of FIG. 2;

FIG. 13 is a sectional view of an expansion tool according to an exemplary embodiment; and

FIG. 14 is a flowchart of a method of securing a fitting to a hose according to an exemplary embodiment.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Referring to FIG. 11, a conventional high-pressure hose fitting 100 is shown. The inner diameter 105 of the hose fitting 100 is 0.145 inches and the fitting 100 is intended for use with a hose having a 0.25 inch internal diameter.

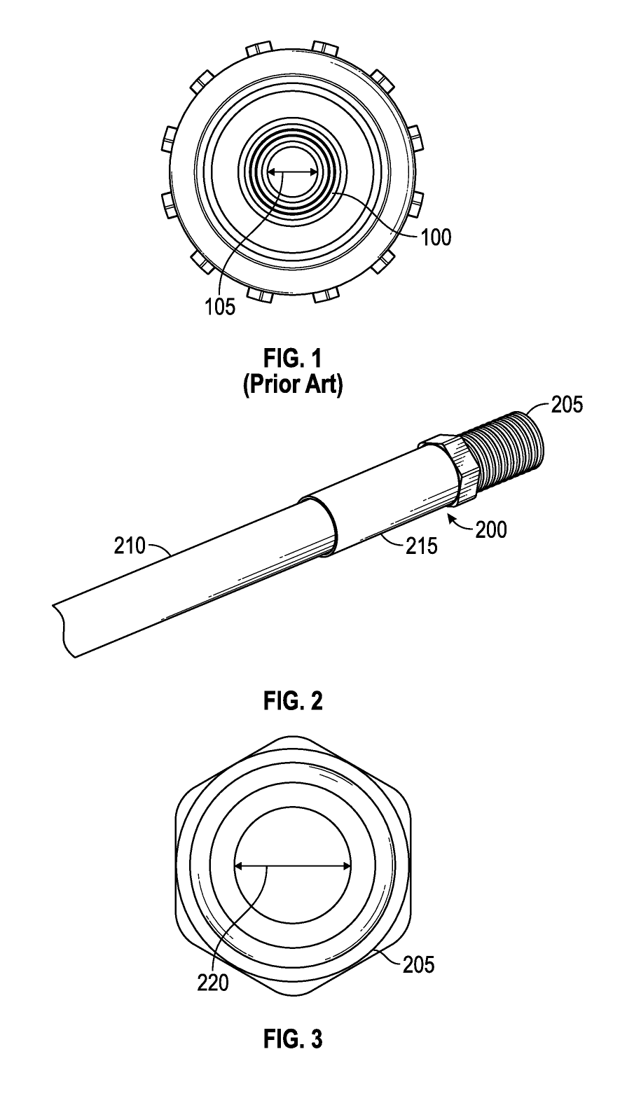

FIG. 2 illustrates a high-flow hose assembly 200, according to an exemplary embodiment. The high-flow hose assembly 200 includes a high-flow hose fitting 205, a hose 210, and a ferrule 215. The high-flow hose fitting 205, the hose 210, and the ferrule 215 are secured together by way of expanding or internally crimping/clamping the high-flow hose fitting 205 in the direction of ferrule 215.

As shown in FIG. 3, the high-flow hose fitting 205 provides a larger inner diameter 220 than the inner diameter 105 of the conventional high-pressure hose fitting 100. This larger diameter produces less of a flow restriction through the high-flow hose fitting 205 than through the conventional high-pressure hose fitting 100. This allows the high-flow hose fitting 205 to conduct higher volumetric flow rates than the conventional high-pressure hose fitting 100 at a given pressure. In an exemplary embodiment, the high-flow hose fitting 205 is intended for use with a hose having a 0.25 inch internal diameter and the inner diameter of the high-flow hose fitting 205 in an expanded state (explained in more detail below) is 0.23 inches.

The large inner diameter of the high-flow hose fitting 205 enables less restricted flow through the fitting, which is advantageous when high-flow applications are desired, as opposed to only high-pressure applications. In a conventional high-pressure hose assembly used with a pressure washer, the connection (e.g., crimp, barb, connector, etc.) between the high pressure hose and the terminal high-pressure hose fitting frequently presents the greatest restriction or size reduction in the high-pressure hose assembly positioned downstream of the water pump,

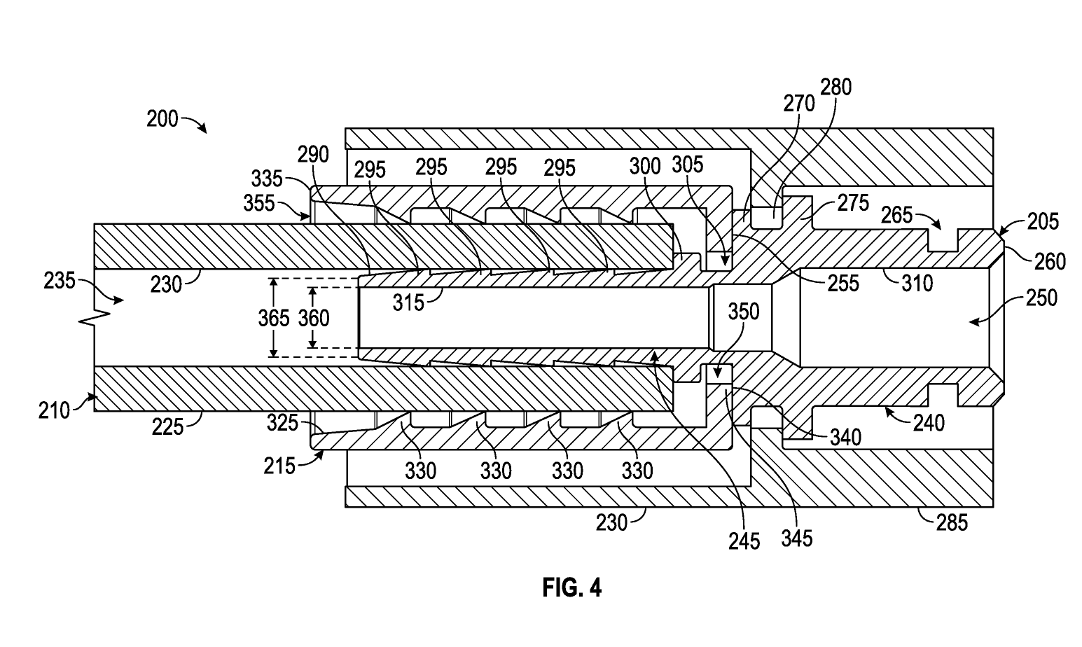

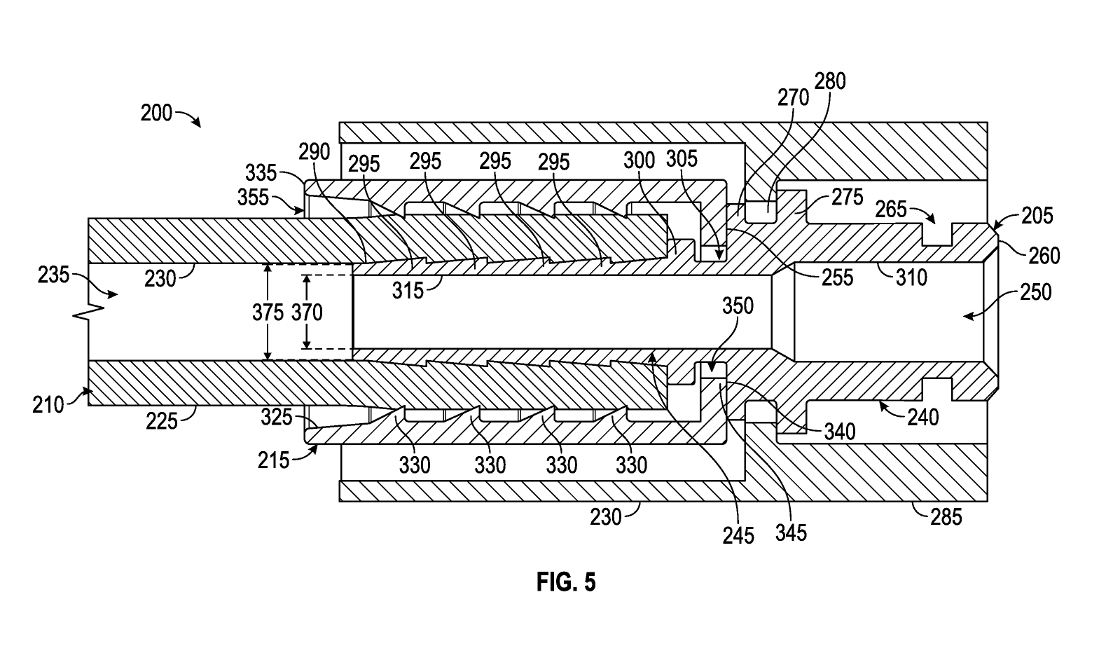

FIGS. 4 and 5 illustrate sectional views of a portion of the high-flow hose assembly 200. FIG. 4 illustrates the high-flow hose assembly 200 in an unsecured configuration with the high-flow hose fitting 205 in an initial configuration. FIG. 5 illustrates the high-flow hose assembly 200 in a secured configuration with the high-flow hose fitting 205 in the expanded configuration.

The hose 210 includes an outer surface 225 and an inner surface 230 arranged substantially concentrically, with the inner surface 230 defining a hose passage 235. The high-flow hose fitting 205 includes a head 240, an insertion portion or stem 245, and a fitting passage 250 that extends through the head 240 and the insertion portion 245.

The head 240 extends between two ends 255 and 260 and includes a channel 265 for receiving an O-ring or gasket to create a seal between the high-flow hose fitting 205 and a corresponding mating fitting (e.g., on another hose, on a spray gun, on a pressure washer, etc.). As shown in the illustrated embodiment, the end 255 opposite the channel 265 is formed as a flange 270 that extends outwardly from the adjacent portion of the head 240. A second flange 275 is spaced apart from the first flange 270 to form a gap 280. The gap 280 may be used to receive a portion of a nut 285, to rotatably attach the nut 285 to the high-flow fitting 205. The nut 285 includes an appropriate coupling structure (e.g., quick-connect, threads, etc.) that is used to secure the corresponding mating fitting to the high-flow hose assembly 200. In some embodiments, the nut 285 includes internal threads. In other embodiments, the head 240 itself includes an appropriate coupling structure (quick-connect, threads, etc.) for coupling the high-flow hose fitting 205 to a corresponding mating coupling fitting (e.g., on another hose, on a spray gun, on a pressure washer, etc.). In alternative embodiments, the nut 285 is rotatably attached to the hose 210 or to the ferrule 215.

The insertion portion 245 extends away from the head 240 from the end 255. The insertion portion 245 has an outer surface 290 including a plurality of fitting barbs 295. A flange 300 extends outwardly from the insertion portion 245. The flange 300 is located between the fitting barbs 295 and the end 255 of the head 240, forming a gap 305. The outer diameter of the flange 300 is greater than the diameter of the inner surface 230 of the hose 210. This allows the flange 300 to act as a stop when inserting the high-flow hose fitting 205 into the hose 210.

The fitting passage 250 is defined by an inner surface 310 of the head 240 and an inner surface 315 of the insertion portion 245. As shown in FIG. 4, the diameter of the inner surface 310 of the head 240 is greater than or equal to the diameter of the inner surface 315 of the insertion portion 245 when the high-flow hose fitting 205 is in the initial configuration. As shown in FIG. 4, the diameter of the fitting passage 250 is greatest near the end 260 of the head 240, transitions to an intermediate size near the intersection of the head 240 and the insertion portion 245, and is smallest along the remainder of the insertion portion 245.

The ferrule 215 includes an outer surface 320 and an inner surface 325 including a plurality of ferrule barbs 330. The inner surface 325 defines a ferrule passage 332. The ferrule 215 extends between two ends 335 and 340. One end 340 forms a shoulder 345 that extends inwardly from the inner surface 325 to define a fitting aperture 350. The other end 335 defines a hose aperture 355 larger in diameter than the fitting aperture 350.

To assemble the high-flow hose assembly 200, as shown in FIG. 4, the insertion portion 245 of the high-flow fitting 205 is slid through the fitting aperture 350 of the ferrule 215 and into the passage 235 of the hose 210 and a portion of the hose 210 is positioned within the ferrule passage 332. The ferrule 215 overlaps or encompasses the area where the insertion portion 245 of the high-flow fitting 205 is located within the hose 210. The flange 300 of the insertion portion 245 stops insertion of the high-flow hose fitting 205 into the hose 210 and the flange 270 of the head stops insertion of the high-flow hose fitting 205 into the ferrule 215. As shown in FIG. 4, in the unsecured configuration of the high-flow hose assembly 200, which includes the high-flow hose fitting 205 in the initial configuration, the inner surface 315 of the insertion portion 245 defines a first diameter 360 and the outer surface 290 of the insertion portion 245 defines a second diameter 365.

As shown in FIG. 5, to securely attach the high-flow fitting 205 to the hose 210, the inside diameter of the fitting passage 250 of the high-flow fitting 205 is expanded (e.g., with a tool as described further below), which also expands the diameter of the outer surface 290 of the insertion portion 245 of the high-flow hose fitting 205. This expansion moves the fitting barbs 295 into engagement with the inner surface 230 of the hose 210. The expansion of the high-flow hose fitting 205 also causes the hose 210 to expand, bringing the outer surface 225 of the hose 210 into engagement with the ferrule barbs 330 (e.g., so that the barbs 330 interfere with, pierce, catch, or otherwise interact with the outer surface 225 of the hose 210). This expansion also moves the flange 300 outwardly so that the outer diameter of the flange 300 is greater than the diameter of the fitting aperture 350, thereby preventing the removal of the insertion portion 245 through the fitting aperture 350. The ferrule 215 helps to secure the high-flow hose fitting 205 to the hose 210, but the ferrule 215 is not deformed (e.g., crimped, clamped, compressed, etc.) in any way. Unlike a ferrule that is deformed by crimping or clamping to secure a convention high-pressure hose fitting (e.g. the high-pressure hose fitting 100) to a hose, the ferrule 215 maintains its shape during the securing process (i.e., the expansion of the high-flow hose fitting 205). As shown in FIG. 5, in the secured configuration of the high-flow hose assembly 200, which includes the high-flow hose fitting 205 in an expanded configuration, the inner surface 315 of the insertion portion 245 defines a third diameter 370 greater than the first diameter 360 and the outer surface 290 of the insertion portion 245 defines a fourth diameter 375 greater than the second diameter 365.

Expanding the high-flow hose fitting 205 to secure the high-flow hose fitting 205 to the hose 210 also helps to ensure a larger inner diameter 220 relative to conventional high-pressure hose fittings (e.g., the high-pressure hose fitting 100) for a given hose inner diameter. Accordingly, the fluid flow restrictions caused by abrupt inner diameter changes between the hose and the fitting as seen in conventional designs may be reduced or eliminated.

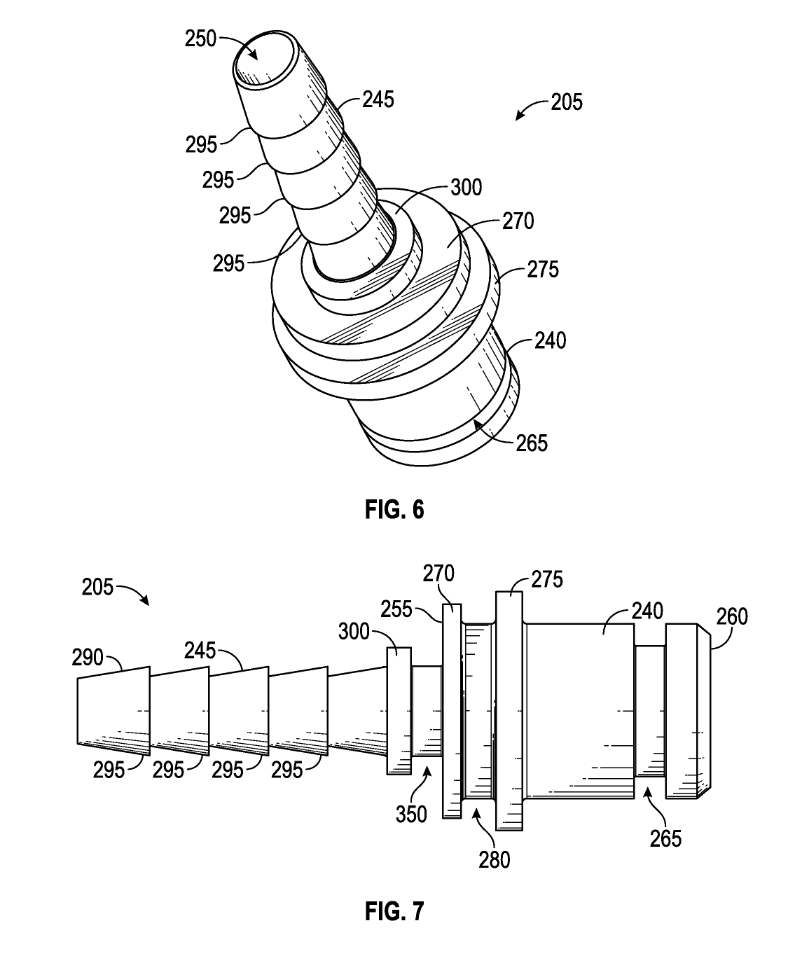

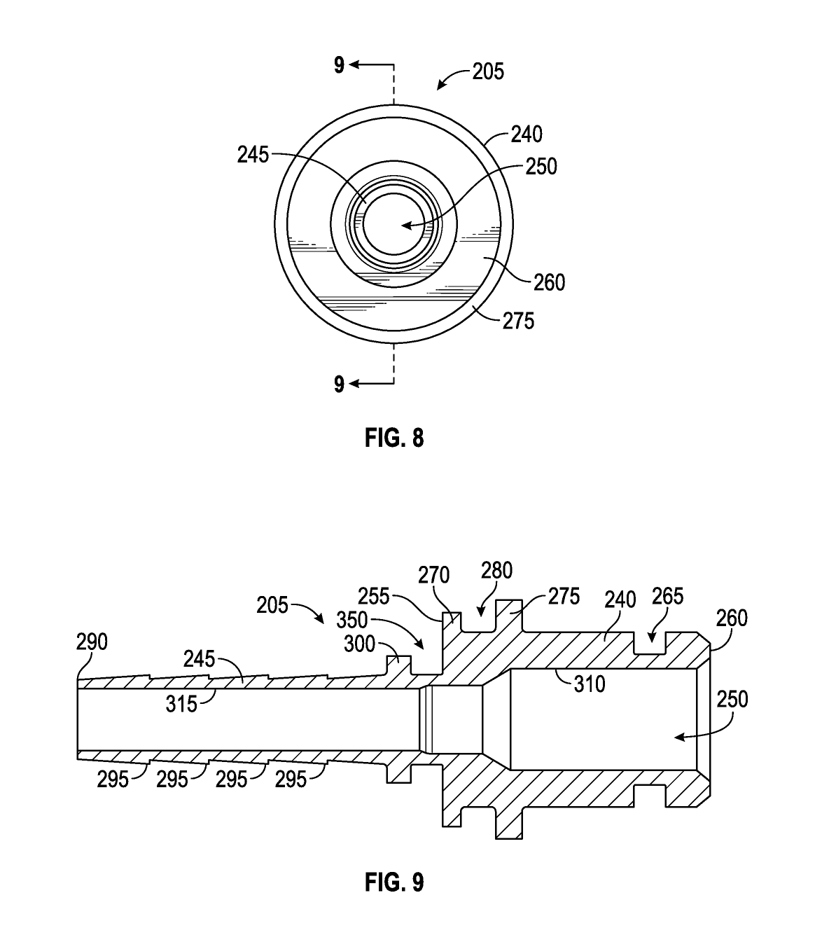

FIGS. 6-9 show additional views of the high-flow hose fitting 205 in the initial configuration. The high-flow hose fitting 205 may be made of any appropriate high-strength yet deformable material. In one exemplary embodiment, the high-flow hose fitting 205 is made of brass. In another exemplary embodiment, the high-flow hose fitting 205 is made of annealed brass. In alternative embodiments, the high-flow hose fitting 205 may be made from metal (steel, aluminum, etc.), polymers, or other suitable materials.

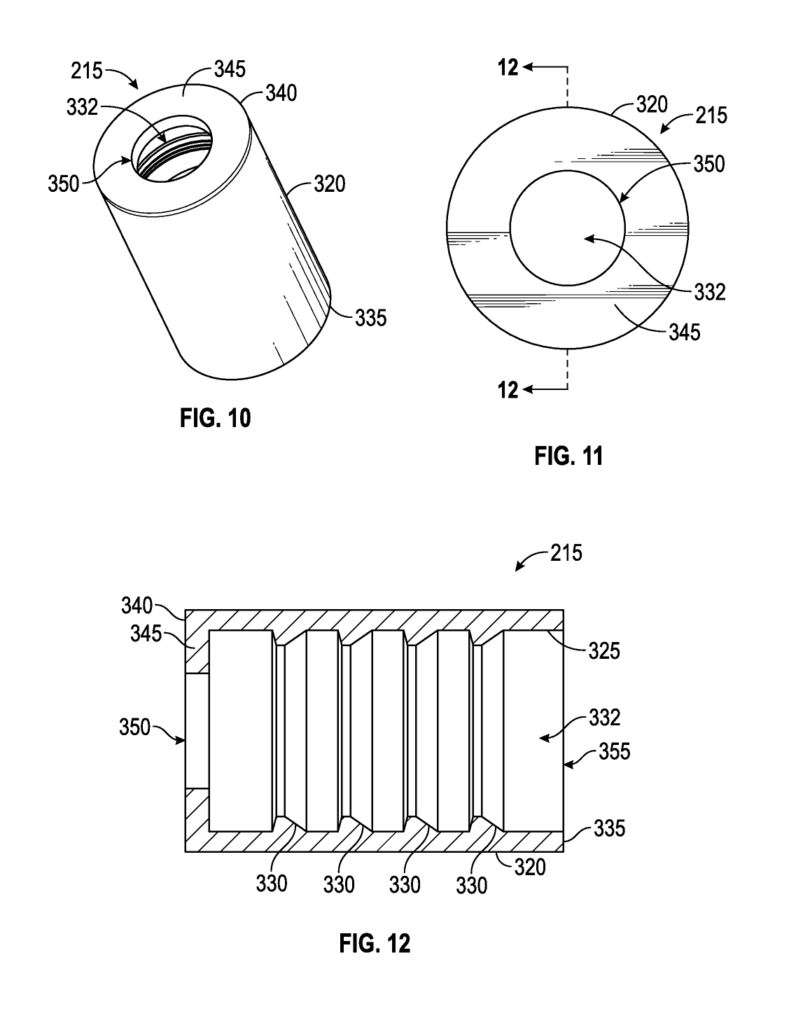

FIGS. 10-12 show additional views of ferrule 215. The ferrule 215 may be made of any appropriate high-strength material, e.g., stainless steel.

The high-flow hose fitting 205 may be expanded from the initial configuration (FIG. 4) to the expanded configuration (FIG. 5) using an appropriate expansion tool that may be inserted within the fitting passage 250 of the high-flow hose fitting 205 and subsequently used (engaged, actuated, etc.) to expand the inside diameter (and hence outside diameter) of the high-flow hose fitting 205.

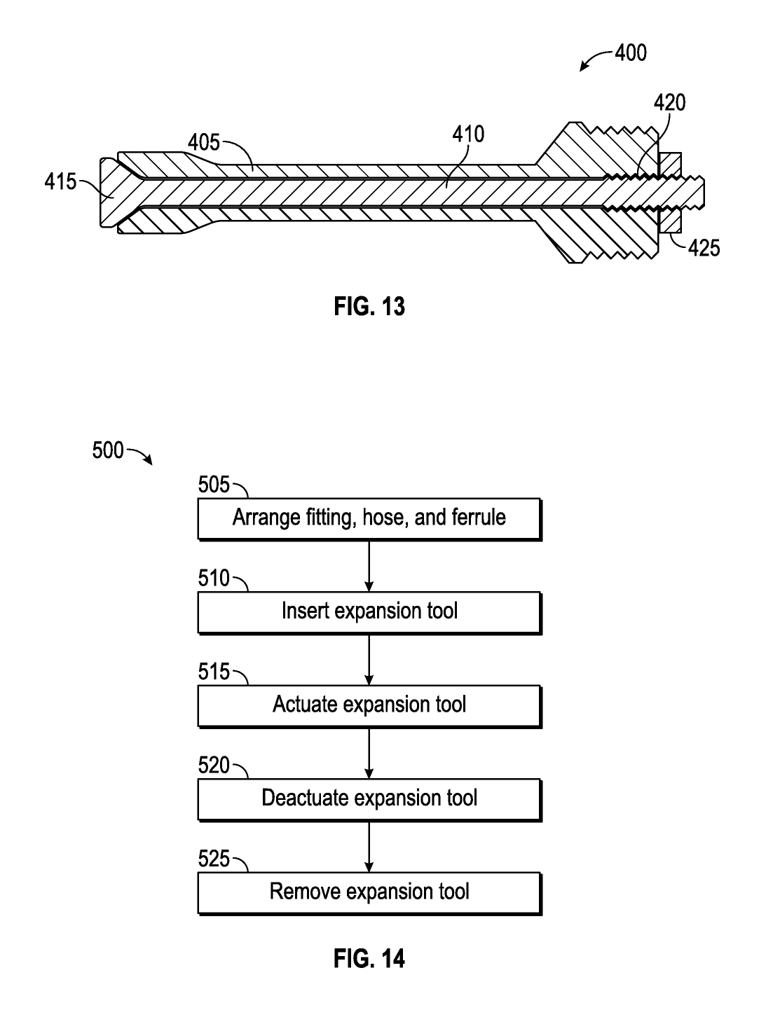

For example, FIG. 13 shows a sectional view of an expansion tool 400 for expanding the inside diameter of the high-flow hose fitting 205. The tool 400 is designed to be inserted within the fitting passage 250 of the high-flow hose fitting 205 when the high-flow hose fitting 205 is positioned within the hose 210 and the ferrule 215. The tool 400 includes an outer expandable shell 405 and an inner shaft 410. The inner shaft 410 includes a flared end 415 and a threaded portion 420. A nut 425 is threadedly engaged with the threaded portion 420. The inner shaft 410 is moved relative to the outer expandable shell 405 by interaction between the threaded portion 420 and the nut 425. That is, as the inner shaft 410 or the nut 425 is rotated in a first direction, the flared end 415 is drawn into the outer expandable shell 405, causing the shell 405 to expand outwardly. This expansion, in turn, expands the high-flow hose fitting 205 and secures the high-flow hose fitting 205 to the hose 210, as described above. Alternatively, instead of the inner shaft 410 being drawn into the outer expandable shell 405, the outer expandable shell 405 could be moved axially along the inner shaft 410 to achieve the same or similar expansion of the shell 405. Alternatively, the expansion tool used to expand the high-flow hose fitting 205 may be similar to a conventional pipe or tube expander. The tube expander may be inserted within the fitting passage 250 of the high-flow hose fitting 205 and, when operated by hand or machine, the tube expander acts to expand the high-flow hose fitting 205.

Referring to FIG. 14, a method 500 of securing a fitting to a hose is illustrated according to an exemplary embodiment. In some embodiments, method 500 is implemented with the high-flow hose assembly 200 and an appropriate expansion tool (e.g., the tool 400). A fitting (e.g., the high-flow hose fitting 205), a hose (e.g., the hose 210), and a ferrule (e.g., the ferrule 215) are arranged so that a barbed portion of the fitting (e.g., the insertion portion 245) is positioned within an end portion of the hose and the end portion of the hose is positioned within a barbed portion of the ferrule (e.g. the ferrule passage 332) (step 505). In some embodiments, the fitting is inserted into the ferrule until an end (e.g., the end 255) of a head of the fitting (e.g. the head 240) abuts an end of the ferrule (e.g. the end 340) and the fitting is inserted into the hose until a flange extending from the barbed portion of the fitting (e.g. the flange 300) abuts an end of the hose. An expansion tool (e.g., the tool 400) is inserted into the fitting (step 510) and actuated to expand the fitting so that the barbed portion of the fitting engages the inner surface of the hose and the barbed portion of the ferrule engages the outer surface of the hose to secure the hose, the fitting, and the ferrule together (step 515). After the fitting has been expand expansion tool is deactuated (step 520) and removed from the fitting (step 525).

The construction and arrangement of the apparatuses, systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, some elements shown as integrally formed may be constructed from multiple parts or elements, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the claims.

What is claimed is:

1. A high-flow hose assembly, comprising:
a hose including an outer surface and an inner surface, wherein the inner surface defines a hose passage;
a fitting including a head, an insertion portion, and a fitting passage extending through the head and the insertion portion, wherein the insertion portion has an outer surface including a plurality of fitting barbs and an inner surface defining a portion of the fitting passage; and
a ferrule including an outer surface and an inner surface including a plurality of ferrule barbs, wherein the inner surface defines a ferrule passage;
wherein, in an unsecured configuration, the insertion portion of the fitting is positioned within the hose passage and the hose is positioned within the ferrule passage, and the inner surface of the insertion portion defines a first diameter and the outer surface of the insertion portion defines a second diameter; and
wherein in a secured configuration, the insertion portion of the fitting is positioned within the hose passage and the hose is positioned within the ferrule passage, and the inner surface of the insertion portion defines a third diameter greater than the first diameter and the outer surface of the insertion portion defines a fourth diameter greater than the second diameter, so that the fitting barbs engage the inner surface of the hose and the ferrule barbs engage the outer surface of the hose to secure the hose, the fitting, and the ferrule together.

2. The high-flow hose assembly of claim 1, further comprising:
a flange extending outwardly from the insertion portion of the fitting, wherein the flange is located between the fitting barbs and the head of the fitting;
wherein the ferrule includes a shoulder extending inwardly from the inner surface of the ferrule to define a fitting aperture;
wherein, in the unsecured configuration, the diameter of the flange is greater than the diameter of the inner surface of the hose and is less than the diameter of the fitting aperture; and
wherein, in the secured configuration, the diameter of the flange is greater than the diameter of the inner surface of the hose and is greater than the diameter of the fitting aperture.

3. The high-flow hose assembly of claim 1, wherein, in the secured configuration, the ferrule is not deformed.

4. The high-flow hose assembly of claim 1, further comprising a nut rotatably attached to the high-flow hose fitting, wherein the nut includes a coupling structure.

5. The high-flow hose assembly of claim 4, wherein the coupling structure comprises a threaded coupling structure.

6. The high-flow hose assembly of claim 4, wherein the coupling structure comprises a quick-connect coupling structure.

7. The high-flow hose assembly of claim 4, further comprising:
a flange extending outwardly from the insertion portion of the fitting, wherein the flange is located between the fitting barbs and the head of the fitting;
wherein the ferrule includes a shoulder extending inwardly from the inner surface of the ferrule to define a fitting aperture;
wherein, in the unsecured configuration, the diameter of the flange is greater than the diameter of the inner surface of the hose and is less than the diameter of the fitting aperture; and
wherein, in the secured configuration, the diameter of the flange is greater than the diameter of the inner surface of the hose and is greater than the diameter of the fitting aperture.

8. The high-flow hose assembly of claim 4, wherein, in the secured configuration, the ferrule is not deformed.

9. A high-flow hose fitting, comprising:
a head including an inner surface;
an insertion portion including an outer surface including a plurality of fitting barbs and an inner surface; and
a fitting passage extending through the head and the insertion portion, wherein the inner surfaces of the head and the insertion portion define the fitting passage; and
wherein, in an initial configuration, the inner surface of the insertion portion defines a first diameter and the outer surface of the insertion portion defines a second diameter; and
wherein in an expanded configuration, the inner surface of the insertion portion defines a third diameter greater than the first diameter and the outer surface of the insertion portion defines a fourth diameter greater than the second diameter.

10. The high-flow hose fitting of claim 9, further comprising:
a flange extending outwardly from the insertion portion of the fitting, wherein the flange is located between the fitting barbs and the head;
wherein, in the initial configuration, the diameter of the flange is a filth diameter; and
wherein, in the expanded configuration, the diameter of the flange is a sixth diameter greater than the fifth diameter.

11. The high-flow hose fitting of claim 9, further comprising a nut rotatably attached to the high-flow hose fitting, wherein the nut includes a coupling structure.

12. The high-flow hose fitting of claim 11, wherein the coupling structure comprises a threaded coupling structure.

13. The high-flow hose fitting of claim 11, wherein the coupling structure comprises a quick-connect coupling structure.

14. The high-flow hose fitting of claim 11, further comprising:
a flange extending outwardly from the insertion portion of the fitting, wherein the flange is located between the fitting barbs and the head;
wherein, in the initial configuration, the diameter of the flange is a fifth diameter; and
wherein, in the expanded configuration, the diameter of the Mange is diameter greater than the fifth diameter.

15. A method of securing a fitting to a hose, comprising:
arranging a fitting, a hose, and a ferrule so that a barbed portion of the fitting is positioned within an end portion of the hose and the end portion of the hose is positioned within a barbed portion of the ferrule;
inserting an expansion tool into the fitting; and
actuating the expansion tool to expand the fitting so that the barbed portion of the fitting engages the inner surface of the hose and the barbed portion of the ferrule engages the outer surface of the hose to secure the hose, the fitting, and the ferrule together.

16. The method of claim 15, further comprising:
deactuating the expansion tool; and
removing the expansion tool from the fitting.

17. The method of claim 15, further comprising:
inserting the fitting into the ferrule until an end of a head of the fitting abuts an end of the ferrule; and
inserting the fitting into the hose until a flange extending from the barbed portion of the fitting abuts an end of the hose.

18. The method of claim 16, further comprising:
deactuating the expansion tool; and
removing the expansion tool from the fitting.
